(19) United States
(12) Patent Application Publication
(10) Pub. No.: US 2013/0216643 A1
(43) Pub. Date: Aug. 22, 2013

(54) SPLIT MOLD INSERT FOR FORMING A NECK PORTION OF A PREFORM AND THE MOLD STACK INCORPORATING SAME

(71) Applicant: Renato Papa, Scarborough (CA)

(72) Inventor: Renato Papa, Scarborough (CA)

(73) Assignee: HUSKY INJECTION MOLDING SYSTEMS LTD, Bolton, ON (CA)

(21) Appl. No.: 13/881,901

(22) PCT Filed: Oct. 3, 2011
(86) PCT No.: PCT/CA11/50621

§ 371 Date: Apr. 26, 2013

Related U.S. Application Data
(60) Provisional application No. 61/411,104, filed on Nov. 8, 2010.

(51) Int. Cl. B29C 49/28

(52) U.S. Cl. CPC B29C 49/28
USPC 425/525

(57) ABSTRACT

There is disclosed a neck ring (308, 310). The neck ring (308, 310) comprises a molding surface 302 (340) for defining a portion of a molded article to be molded; a first male taper (318) projecting from a body of the neck ring (308, 310); and a second male taper (320) located proximate to an outer lateral periphery of the body of the neck ring (308, 310); wherein the first male taper and the second male taper are configured to cooperate with respective female tapers that are associated with a cavity flange.

### FIELD OF THE INVENTION

The present invention generally relates to, but is not limited to, molding systems, and more specifically the present invention relates to, but is not limited to, a split mold insert for forming a neck portion of a preform and a mold stack incorporating same.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from Polyethylene Teraphalate (PET) material is a preform that is capable of being subsequently blown into a beverage container, such as, a bottle and the like.

As an illustration, injection molding of PET material involves heating the molding material (ex. PET pellets, PEN powder, PLA, etc.) to a homogeneous molten state and injecting, under pressure, the so-melted PET material is injected into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, etc.

When dealing with molding a preform that is capable of being blown into a beverage container, one consideration that needs to be addressed is forming a so-called “neck portion”. Typically and as an example, the neck portion includes (i) threads (or other suitable structure) for accepting and retaining a closure assembly (ex. a bottle cap), and (ii) an anti-pilferage assembly configured to cooperate, for example, with the closure assembly to indicate whether the end product (i.e. the beverage container that has been filled with a beverage and shipped to a store) has been tampered with in any way. The neck portion may comprise other additional elements used for various purposes, for example, to cooperate with parts of the molding system (ex. a support ledge, etc.). As is appreciated in the art, the neck portion can not be easily formed by using the cavity and core halves. Traditionally, split mold inserts (sometimes referred to by those skilled in the art as “neck rings”) have been used to form the neck portion.

With reference to FIG. 1, a section along a portion of an injection mold 50 illustrates a portion of typical molding insert stack assembly 60 that is arranged within a molding system (not depicted). The description of FIG. 1 that will be presented herein below will be greatly simplified, as it is expected that one skilled in the art will appreciate general configuration of other components of the injection mold 50 that will not be discussed in the following description.

The molding insert stack assembly 60 includes a neck ring insert pair 52 that together with a mold cavity insert 54, a gate insert (not shown) and a core insert 61 define a molding cavity (not separately numbered) where molding material can be injected to form a molded article, such as a perform 63. In order to facilitate forming of the neck portion of the preform 63 and subsequent removal of the preform 63, the neck ring insert pair 52 comprises a pair of complementary neck ring inserts that are mounted on adjacent slides of a slide pair 68. The slide pair 68 is slidably mounted on a top surface of a stripper plate 66. As commonly known, and as, for example, generally described in U.S. Pat. No. 6,799,962 to Mai et al (granted on Oct. 5, 2004), the stripper plate 66 is configured to be movable relative to a cavity plate assembly 74 and a core plate assembly (not depicted), when the mold is arranged in an open configuration, whereby the slide pair 68, and the complementary neck ring insert pair 52 mounted thereon, can be laterally driven, via a cam arrangement or some other means (not shown), for the release of the molded article from the molding cavity.

A typical neck ring insert has a body that includes a pair of projecting portions 70 that extend from a top and a bottom face of a flange portion 72 (i.e. a top projecting portion and a bottom projecting portion). Typically, the bottom face of the flange portion 72 abuts, in use, a top surface of the slide pair 68. Even though not depicted in FIG. 1, one skilled in the art will appreciate that the neck ring insert pair 52 cooperates with suitable fasteners for connecting to a respective one of the slide pair 68. In use, during certain portions of a molding cycle, the top projecting portion cooperates with a female receptacle disposed on the cavity plate assembly 74.

FIG. 2 depicts an example of a prior art implementation of a neck ring 200 of the neck ring insert pair 52. More specifically, FIG. 2 depicts a front planar view of the neck ring 200. The neck ring 200 comprises a molding surface 202 for forming, in use, various portions of the neck finish of the preform and a mating surface 204 for abutting, in use, another one of the neck ring 200. The neck ring 200 further includes an upper male taper 210 and a lower male taper 212, jointly referred to as aligning tapers. As is known, the aligning tapers perform an aligning function during mold closing operation. Those skilled in the art typically refer to the design of the neck ring 200 of FIG. 2 as a core lock design type. It is also known to implement one of the aligning tapers as a female taper (not depicted). Those skilled in the art typically refer to this alternative design as a cavity lock design type.

U.S. Pat. No. 3,647,337 to Dega, issued on Mar. 7, 1972, teaches an apparatus for injection molding dimensionally precise tubular elastomeric articles. The apparatus includes male and female mold members longitudinally movable relative to each other and adapted to form a tubular cavity therebetween, longitudinally and transversely disposed precision alignment surfaces, and means whereby an annular injection orifice is provided at one end of the cavity while the other end is provided with an annular vent opening and evacuation means. In the molding process, elastomeric material is injected into the cavity through the orifice until the mold cavity is filled. Thereafter, pressure is applied to the mold whereby the orifice and the annular vent opening are restricted and the material is subjected to a uniform pressure at all points within the mold cavity to produce a dimensionally precise elastomeric product.

U.S. Pat. No. 4,775,130 issued to Von Holdt on Oct. 4, 1988, discloses a mold, typically an injection mold, having a mold core and a mold cavity, has centering rib means at its parting line defined on one of the core and cavity, projecting in the closed position into a groove defined by the other of the mold core and cavity in the closed position. By this invention a wear member is removably secured in the groove at a position which is radially inward of the centering rib. The wear member defines a radially outer face that is acutely angled outwardly from the longitudinal axis of the mold relative to the centering rib. The radially inner surface of the centering rib defines a plane parallel to the radially outer face and positioned whereby the radially outer face and radially inner surface abut each other in the closed position. The radially outer surface of the centering rib is acutely angled inwardly relative to the longitudinal axis and centering rib means, the radially outer surface being parallel to and substantially in abutting relation with the radially outer side of the groove in the closed position. The wear member may be designed to endure most of the wear that takes place in the mold centering system during operation. Then, the wear member, which is relatively inexpensive, may be replaced after it is unduly worn, resulting in a great improvement in mold maintenance

U.S. Pat. No. 4,856,977 also issued to Von Holdt on Aug. 15, 1989, discloses a mold comprising a mold core and mold cavity defines means which permits and controls a slight outward stretching of the mold cavity from a first positively centered position to a second positively centered position. By this means, precision centering of the mold and core can be achieved even under ultra high molding pressures without significant core shift.

U.S. Pat. No. 4,986,944 to Bertschi, issued on Jan. 22, 1991, teaches a method and apparatus for effecting an accurate, close tolerance guidance between relative movable male and female mold elements operable at high speed to mold thin wall articles free of the risk of mold damage due to relatively small occurrences of mold misalignment.

U.S. Pat. No. 5,874,038 to Kasashima et al., issued on Feb. 23, 1999, discloses an injection mold for golf balls includes a pair of separable mold segments (1a, 1b). The mold segments (1a, 1b) are mated at their peripheral surfaces (12) along a parting line so that their inner surfaces (2a) define a spherical cavity (2). A plurality of dimple-forming projections (11) are formed on the inner surfaces (2a). At least four tubular gates (7) are disposed in the peripheral surfaces (12) and in fluid communication with the cavity (2). The peripheral surfaces (12) are furrowed except for the areas where the gates are disposed. Dimple-forming pins (14) are received in furrows (13) so as to lie across the parting line (PL). A molten stock material is injected into the cavity (2) through the gates (7) to mold a golf ball having dimples lying across the parting line.

U.S. Pat. No. 6,632,078 issued to Ogg et al. on Oct. 14, 2003, teaches a golf ball mold having non-planar parting lines and a method for forming a cover using such mold are disclosed herein. The mold has a pair of mold halves, and each mold half has a non-planar perimeter. The non-planar perimeter has alternating extensions and indentations. Each of the extensions has an apex that may be curved, and each of the indentations has a depression that may be curved. The mold may be used in compression molding, injection molding and cast molding a layer on a golf ball. The mold may be used to produce golf balls having non-dimpled surfaces.

Further, U.S. Pat. No. 7,128,865 to Martin, issued on Oct. 31, 2006, teaches an injection molding method and apparatus for ejecting a molded plastic preform from a mold. A first lifting structure and/or step is configured to have an inner surface with an area for sealing and aligning with a complementary surface on a core, and to have an upper surface with an area for sealing and aligning with a complementary surface on a second lifting structure, said upper surface of said first lifting structure being configured to lift a molded plastic preform from the injection mold in a lifting direction for a first period of time, the lower portion of the molded plastic preform lying in a plane substantially perpendicular to the lifting direction. A second lifting structure and/or step is configured to have an inner surface configured to lift an outer surface of the molded plastic preform from the injection mold in the lifting direction for a second period of time, the outer surface of the molded plastic preform including structure lying in a plane substantially parallel with the lifting direction. Since the molded plastic preform is lifted by its end, the preform does not have to be solidified at its interior, thus allowing earlier removal of the preform from the mold, reducing cycle time.

U.S. Pat. No. 5,336,078 issued to Catoen on Aug. 9, 1994, discloses the present invention relates to an apparatus for injection molding a thin-walled plastic article with substantially equal thickness sidewalls, a base portion, and a lip portion. The apparatus includes a two part mold arrangement in which a first part defines has a mold cavity and a second part defines a mold core. The first and second mold parts in a mold closed position define a mold space in the shape of the article being molded. The apparatus further includes two or more gates adjacent a lip portion of the mold space for injecting molten plastic material into the mold space and a bottom center venting arrangement. The apparatus further includes a restriction in the mold space for improving the operation of the bottom center venting arrangement and providing a more balanced filling in a multi-cavity molding machine.

U.S. Pat. No. 7,628,605 issued to Mai et al. on Dec. 8, 2009 discloses, according to embodiments of the present invention, there are provided a mold stack, a molding system incorporating same and a method of aligning the mold stack. For example, a mold stack is provided. The mold stack comprises a first molding cavity defining component, a second molding cavity defining component and a third molding cavity defining component, with the second molding cavity defining component being located, in use, in-between the first molding cavity defining component and the third molding cavity defining component. At least one of the first molding cavity defining component and the third molding cavity defining component is associated with a respective compensator, the respective compensator configured to allow the at least one of the first molding cavity defining component and the third molding cavity defining component to align itself relative to the second molding cavity defining component

U.S. Pat. No. 5,736,173 to Wright et al., issued on Apr. 7, 1998, discloses a preform injection mould includes an elongate mould core cooperating with a female mould and a neck ring in a manner to define a mould cavity therebetween. An injection nozzle in the female mould allows molten plastic to be injected into the mould cavity so that a preform moulded article may be formed. The neck ring is constituted by a pair of mating halves which can be separated laterally with respect to the longitudinal axis of the mould core. A taper sleeve surrounds the mould core beneath the neck ring. The neck ring halves are secured to diametrically opposed slides to facilitate lateral separation of the neck ring. A pair of slide taper locks contact a respective one of the slides to inhibit lateral movement of the slides and to back up the neck ring when injection mould is in a mould closed position. An annular formation is formed on the upper surface of the neck ring and is accommodated by a complementary recess formed in the bottom of the female mould. The mating inclined surfaces of the female mould and the annular formation constitute an upper taper lock which is backed up by a cavity plate. An annular formation is provided on the upper surface of the taper sleeve and is accommodated by a complimentary recess formed in the bottom of the neck ring. The mating inclined surfaces of the taper sleeve and neck ring constitute a lower taper lock. Since a portion of the neck ring constitutes the female taper of the lower taper lock, the lower taper lock is backed up by the slide taper locks through the slides allowing the cross-sectional area of the neck ring to be reduced.

U.S. Pat. No. 5,776,517 issued to Ciccone et al. on Jul. 7, 1998 teaches an adjustable clamping or locking wedge is disclosed for use in an injection mold press. The clamping wedge has a main body portion with a main oblique wedging surface adapted to be engaged by a moving portion of a closing mold. The main body portion has a second oblique wedging surface located transversely of the main oblique wedging surface. A wedge is located for sliding engagement against the second wedging surface and supports the main body portion, and a threaded fastener is mounted between the main body portion and the wedge for moving the wedge and adjusting the position of the main oblique wedging surface in the mold press.

US Patent Application Publication No. 2008/0026239 to Balboni et al., published on Jan. 31, 2008, discloses the preform is formed by an upper neck which maintains unchanged its form in the final object and a hollow body, joined to the neck. The method foresees the insertion, within a matrix cavity, of a metered body of polymeric material whose mass is metered according to a reference value, and the subsequent pressure insertion of a punch within the matrix cavity until it closes the mold's molding chamber, the punch conferring the shape to the inner surface of the preform and the matrix having an inner surface which confers the shape to the outer surface of the preform. According to the invention, in the molding of the preform, the error of the mass of the metered body with respect to the reference value is distributed in the hollow body, which undergoes a subsequent hot deformation until it achieves the final shape. In the mold, the matrix comprises at least one deformable wall (31) whose inner surface defines at least part of the inner surface of the matrix part intended to give form to the hollow body of the preform, said deformable wall (31) having, at least in part, a relatively thin thickness which permits it to be elastically deformed under the pressure of the polymeric material in the final preform molding step, thereby varying the thickness of the hollow body.

US Patent Application Publication No. 2009/0020915 to Mai et al., published on Jan. 22, 2009, teaches, according to embodiments of the present invention, there are provided a mold stack, a molding system incorporating same and a method of aligning the mold stack. For example, a mold stack is provided. The mold stack comprises a first molding cavity defining component, a second molding cavity defining component and a third molding cavity defining component, with the second molding cavity defining component being located, in use, in-between the first molding cavity defining component and the third molding cavity defining component. At least one of the first molding cavity defining component and the third molding cavity defining component is associated with a respective compensator, the respective compensator configured to allow the at least one of the first molding cavity defining component and the third molding cavity defining component to align itself relative to the second molding cavity defining component.

US Patent Application Publication No. 2008/0268083 to Ferenc, published on Oct. 30, 2008, discloses according to embodiments of the present invention, there is provided a split mold insert. The split mold insert comprises a body comprising: a front face portion defining, in part, a first portion of a molding cavity; a planar upper face portion for cooperation with a complementary lower portion of a first mold insert, the first mold insert defining a second portion of the molding cavity; the planar upper face portion defining a split line between the first and second portions of the molding cavity; a locking interface defined on an outermost portion of the body, the locking interface configured to cooperate with a blocking member associated with a cavity mold insert.

Finally, US Patent Application Publication No. 2008/0265463 to Finkelstein, published on Oct. 30, 2008, teaches, according to the embodiments of the present invention, there is provided a split mold insert positioning device and a method of use thereof. More specifically, a split mold insert positioning device is provided. The split mold insert positioning device comprises a split mold insert positioning interface dimensioned in a complementary arrangement to a reference dimension of a given split mold insert; and a tooling interface for providing access to the given split mold insert when the split mold insert positioning interface is positioned over the given split mold insert.

### SUMMARY OF THE INVENTION

According to a first broad aspect of the present invention, there is provided a neck ring. The neck ring comprises a molding surface for defining a portion of a molded article to be molded; a first male taper projecting from a body of the neck ring; and a second male taper located proximate to an outer lateral periphery of the body of the neck ring; wherein the first male taper and the second male taper are configured to cooperate with respective female tapers that are associated with a cavity flange.

According to a second broad aspect of the present invention, there is provided a mold stack portion comprising neck ring and a cavity flange; the neck ring including: a molding surface for defining a portion of a molded article to be molded; a first male taper projecting from a body of the neck ring; and a second male taper located proximate to an outer lateral periphery of the body of the neck ring; the cavity flange including a first cavity female taper and a second cavity female taper; wherein the first male taper is configured to cooperate with the first cavity female taper and the second male taper is configured to cooperate with the second cavity female taper.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

A better understanding of the embodiments of the present invention (including alternatives and/or variations thereof) may be obtained with reference to the detailed description of the exemplary embodiments along with the following drawings, in which:

FIG. 1 depicts a cross-section along an operational axis of a molding stack implemented in accordance with known techniques.

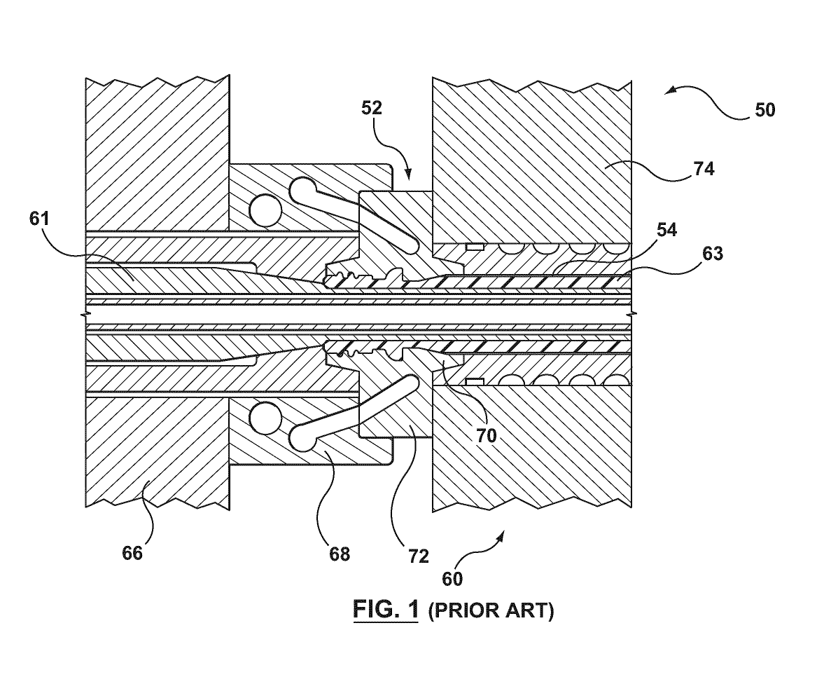

FIG. 2 is a front planar view of a neck ring of the molding stack of FIG. 1, implemented in accordance with known techniques.

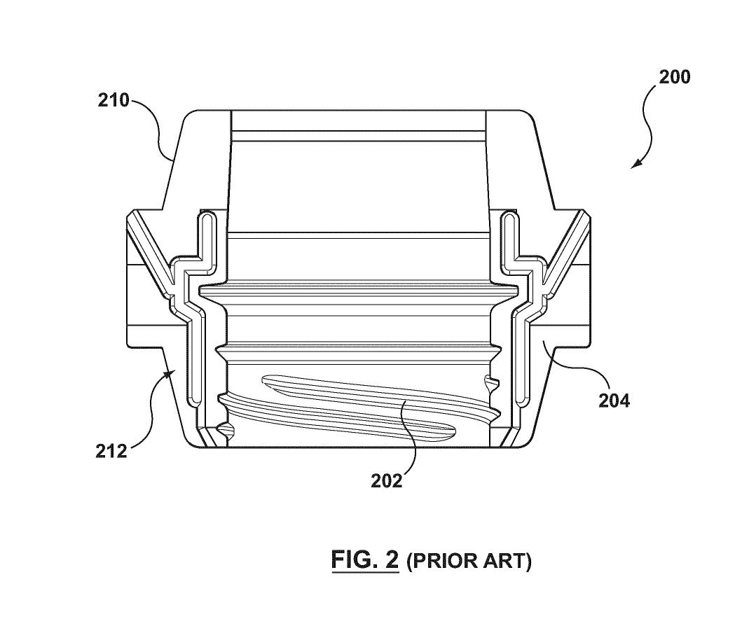

FIG. 3 is a cross-section along an operational axis of a portion of a molding stack implemented in accordance with a non-limiting embodiment of the present invention.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF EMBODIMENTS

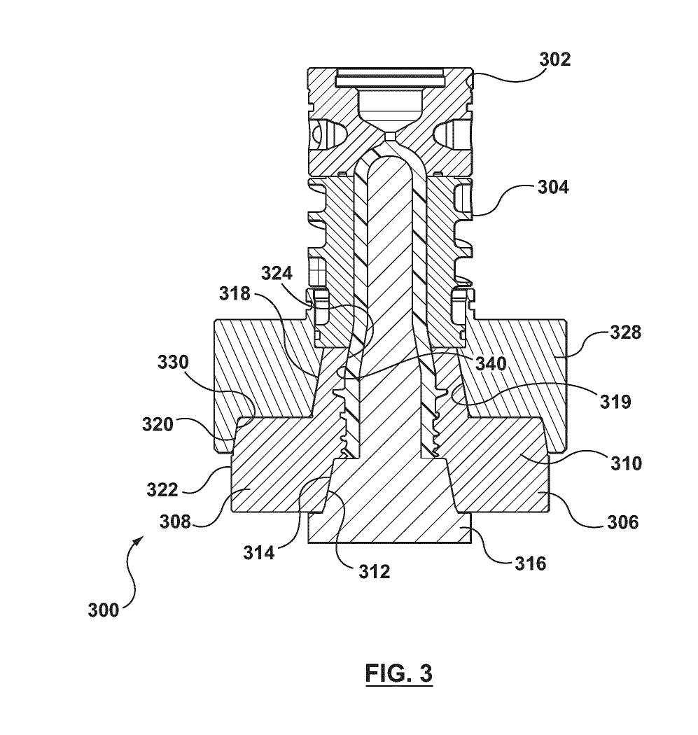

With reference to FIG. 3, a portion of a mold stack 300, a portion of which is implemented in accordance with non-limiting embodiments of the present invention, is depicted. The mold stack 300 includes inter alia a gate insert 302 and a cavity insert 304. It is noted that the gate insert 302 and the cavity insert 304 can be implemented in accordance with various known prior art techniques. As such, these components will not be described here at any length, as those of ordinary skill in the art will appreciate details of their construction.

The mold stack 300 further comprises a neck ring pair 306 implemented in accordance with embodiments of the present invention. The neck ring pair 306 includes a first neck ring 308 and a second neck ring 310, which are implemented in substantially the same manner and, as such, description of one will apply mutatis mutandis to the description of the other one. To that end, the first neck ring 308 includes a neck ring female taper 312. The neck ring female taper 312 cooperates, in use, with a core male taper 314 located on a core insert 316, the core insert 316 implemented substantially in accordance with various known prior art techniques. Accordingly, the neck ring pair 306 can be said to be of a cavity lock design type. It should be noted, however, that the teachings of embodiments of the present invention can also be applied mutatis mutandis to the core lock type of neck rings.

The first neck ring 308 further comprises a first male taper 318. The first male taper 318 projects from a body of the first neck ring 308 upwardly (as viewed in FIG. 3). In can be appreciated from the illustration of FIG. 3 that the first male taper 318 projects from a first side opposite to a second side where the neck ring female taper 312 is defined. The first male taper 318 is configured to cooperate, in use, with a first cavity female taper 319 defined on a cavity flange 328 (to be described herein below).

The height associated with the first male taper 318, within a specific embodiment depicted herein, can constitute to 60% coverage of a molding surface 340. In other words, the height of the first male taper 318 is approximately 60% of the height of the molding surface 340. In alternative embodiments, the coverage of the height of the first male taper 318 vis-à-vis the molding surface could be less or more then 60% of the embodiment depicted herein. For example, in one specific alternative non-limiting embodiment, the coverage can be approximately 80% (particularly applicable in non-tight pitch implementations).

The first male taper 318 is associated with a first angle defined between a tapered portion thereof and a vertical axis (as viewed in FIG. 3 and not separately depicted) of the neck ring pair 306 and the mold stack 300. In some embodiments of the present invention, the first angle can be 15 degrees. However, in alternative embodiments, the first angle can be implemented differently.

The first neck ring 308 further comprises a second male taper 320, which can be thought of as a “secondary” or “auxiliary” male taper vis-à-vis the first male taper 318. The second male taper 320 is located more proximate to an outer periphery 322 of the first neck ring 308 vis-à-vis the location of the first male taper 318. By the same token, it can be said that the first male taper 318 is located more proximate to an inner periphery 324 of the first neck ring 308 vis-à-vis the location of the second male taper 320. The outer periphery 322 can be also thought of as an outer lateral periphery. Accordingly, it can be said that the second male taper 320 is located substantially proximate to the outer lateral periphery of a body of the first neck ring 308 (for the avoidance of doubt, “outer lateral” is referring to a direction as viewed in FIG. 3).

The height associated with the second male taper 320, within a specific embodiment depicted herein, can be approximately 8 mm. However, in alternative non-limiting embodiments, the second male taper 320 may be associated with a different height. The second male taper 320 is associated with a second angle defined between a tapered portion thereof and a vertical axis (as viewed in FIG. 3 and not separately depicted). In some embodiments of the present invention, the second angle can be implemented with the same angle degree as the first angle, which in this example is 15 degrees. However, in alternative embodiments, both the first and second angles can be implemented differently (or, in other words, both the first and second angles can be implemented at a degree different then 15 degrees, but the same therebetween). In yet further embodiments, the second angle can be different from the first angle. As examples of alternative embodiments for the second angle, the second angle can be implemented as 7 degree angle or, as another example only, as a 10 degree angle. Other implementations of less or more then 15 degrees are possible.

In some embodiments of the present invention, the second male taper 320 can be produced by turning and grinding. In alternative embodiments, the second male taper 320 can be produced by other manufacturing methods.

The mold stack 300 further comprises the cavity flange 328. Even though in the depicted embodiment, the cavity flange 328 is separately made from the cavity insert 304, in alternative non-limiting embodiments of the present invention, the cavity flange 328 and the cavity insert 304 can be integrally made. The cavity flange 328 comprises a second cavity female taper 330, which cooperates, in use, with the second male taper 320. In some embodiments of the present invention, the second male taper 320 and the second cavity female taper 330 are implemented without a preload and in some embodiments with a preload. In some embodiments of the present invention, the second male taper 320 and the second cavity female taper 330 are implemented in an interference fit. In some embodiments of the present invention, the second male taper 320 and the second cavity female taper 330 are implemented in a clearance fit. In some embodiments of the present invention, the second male taper 320 and the second cavity female taper 330 are implemented in a size-on-size fit.

Accordingly, it can be said that the first male taper 318 and the second male taper 320 cooperate with respective female cavity tapers (i.e. the first cavity female taper 319 and the second cavity female taper 330).

In use, when a load is applied to the mold stack 300 through known means, the second male taper 320 and the second cavity female taper 330 abut each other and, in effect, the second cavity female taper 330 is further acting as a delimiter or preventer of the separation of the neck ring pair 306.

Accordingly, what has been described is the first male taper 318 which primary function is to guide, locate and hold closed the neck ring pair 306 when the mold stack 300 is being closed and a second male taper 320 which function is to assist in preventing separation of the neck ring pair 306. Due to this partial separation of functions between the first male taper 318 and the second male taper 320, one gets more flexibility in designing the first male taper 318. For example, the first male taper 318 may be made of a lesser height, yet the neck ring pair 306 may still withstand higher injection pressure (compared to the prior art design with the same height tapers) due to the delimiting effect of the second male taper 320).

A technical effect of embodiments of the present invention includes provision of a neck ring pair 306 which allows to substantially reduce the risk of flash due to neck ring pair 306 splitting without introduction of any additional components for the purposes of delimiting the splitting of the neck ring pair 306, in use while molding. Another technical effect of embodiments of the present invention includes ease of manufacturing of such means for preventing the splitting of the neck ring pair 306. Another technical effect of embodiments of the present invention may include reduced tolerance stack ups. It should be expressly understood that not each and every technical effect needs to be realized in each and every embodiment of the present invention.

The description of the embodiments of the present inventions provides examples of the present invention, and these examples do not limit the scope of the present invention. It is to be expressly understood that the scope of the present invention is limited by the claims only. The concepts described above may be adapted for specific conditions and/or functions, and may be further extended to a variety of other applications that are within the scope of the present invention. Having thus described the embodiments of the present invention, it will be apparent that modifications and enhancements are possible without departing from the concepts as described. Therefore, what is to be protected by way of letters patent are limited only by the scope of the following claims:

1. A neck ring (308, 310), comprising:
a molding surface (340) for defining a portion of a molded article to be molded;
a first male taper (318) projecting from a body of the neck ring (308, 310); and
a second male taper (320) located proximate to an outer lateral periphery of the body of the neck ring (308, 310);
wherein the first male taper (318) and the second male taper (320) are configured to cooperate with respective female tapers (319, 330) that are associated with a cavity flange (328).

2. The neck ring (308, 310) of claim 1, wherein the first male taper (318) is associated with a first angle vis-à-vis a vertical axis of the neck ring (308, 310) and the second male taper (320) is associated with a second angle vis-à-vis the vertical axis.

3. The neck ring (308, 310) of claim 2, wherein the first angle and the second angle are the same.

4. The neck ring (308, 310) of claim 2, wherein the first angle and the second angle are implemented as 15 degree angles.

5. The neck ring (308, 310) of claim 2, wherein the first angle and the second angle are different.

6. The neck ring (308, 310) of claim 1, wherein the second male taper (320) cooperates, in use, with a second cavity female taper (330) defined on the cavity flange (328).

7. The neck ring (308, 310) of claim 6, wherein the second male taper (320) and the second cavity female taper (330) are implemented without a preload.

8. The neck ring (308, 310) of claim 6, wherein the second male taper (320) and the second cavity female taper (330) are implemented in an interference fit.

9. The neck ring (308, 310) of claim 6, wherein the second male taper (320) and the second cavity female taper (330) are implemented in a clearance fit.

10. The neck ring (308, 310) of claim 6, wherein the second male taper (320) and the second cavity female taper (330) are implemented as size-on-size.

11. The neck ring (308, 310) of claim 1, wherein the second male taper (320) is produced by turning and grinding.

12. The neck ring (308, 310) of claim 1, wherein the first male taper (318), in use, performs the functions of guiding and locating and the second male taper (320), in use, performs the function of delimiting separation of the neck ring (308, 310) form a complimentary neck ring (308, 310).

13. The neck ring (308, 310) of claim 1, further comprising a neck ring female taper (312);
the neck ring female taper (312) is configured to cooperate, in use, with a core male taper (314) that is associated with a core insert (316)

14. A mold stack portion (300) comprising:
neck ring (308, 310) and a cavity flange (328); the neck ring (308, 310) including:
a molding surface (340) for defining a portion of a molded article to be molded;
a first male taper (318) projecting from a body of the neck ring (308, 310); and
a second male taper (320) located proximate to an outer lateral periphery of the body of the neck ring (308, 310);
the cavity flange (328) including a first cavity female taper (319) and a second cavity female taper (330);
wherein the first male taper (318) is configured to cooperate with the first cavity female taper (319) and the second male taper (320) is configured to cooperate with the second cavity female taper (330).

15. The mold stack portion (300) of claim 114, wherein the cavity flange (328) is integrally made with a cavity insert (304).

16. The mold stack portion (300) of claim 14, wherein the cavity flange (328) is separately made from a cavity insert (304) but is operatively coupled thereto, in use.

17. The mold stack portion (300) of claim 14, wherein the first male taper (318), in use, performs the functions of guiding and locating and the second male taper (320), in use, performs the function of delimiting separation of the neck ring (308, 310) form a complimentary neck ring (308, 310).

18. The mold stack portion (300) of claim 14, wherein the neck ring (308, 310) further comprises a neck ring female taper (312) and wherein the neck ring female taper (312) is configured to cooperate, in use, with a core male taper (314) that is associated with a core insert (316).
